(19) United States
(12) Patent Application Publication
(10) Pub. No.: US 2003/0155411 A1
(43) Pub. Date: Aug. 21, 2003

(54) Blank for filing box

(76) Inventors: Roberto Yango Soteriou, Streatham (GB); Piero Theodore Soteriou, Streatham (GB)

Correspondence Address: WELLS ST. JOHN ROBERTS GREGORY & MATKIN P.S., 601 W. FIRST AVENUE, SUITE 1300, SPOKANE, WA, 99201-3828, US

(21) Appl. No.: 10/258,315

(22) PCT Filed: Apr. 19, 2001
(86) PCT No.: PCT/GB01/01766

(30) Foreign Application Priority Data
Apr. 20, 2000 (GB) 0009903.6

(51) Int. Cl. B65D 5/10; B26D 5/42

(52) U.S. Cl. 229/155; 229/198.2

(57) ABSTRACT

A blank is provided for the construction of a file storage box, the blank being formed from a single sheet of material, and having first and second substantially identical rectangular panels (1, 10) joined together by a third rectangular panel (8) at respective first and second fold lines (9, 11). Fourth and fifth substantially identical rectangular panels (2, 3) are joined to the first panel (1) at opposite sides thereof by third and fourth fold lines (4, 5) at right-angles to the first fold line (9). Sixth and seventh substantially identical rectangular panels (12, 13) are joined to the second panel (10) at opposite sides thereof by fifth and sixth fold lines (14, 15) at right-angles to the second fold line (11). The fourth and fifth panels (2, 3) are each provided with at least one tongue (6) joined thereto on that edge opposite to the respective third or fourth fold line (4, 5), and the sixth and seventh panels (12, 13) are each provided with at least one pre-cut (16) formed in the region of the respective fifth or sixth fold line (14, 15). The blank is foldable about the fold lines to form a file storage box of which the sides are constituted by the first and second panels (1, 10), the base is constituted by the third panel (8), the front is constituted by the fourth and sixth panels (2, 12) and the rear is constituted by the fifth and seventh panels (3, 13). The tongues (6) and the pre-cuts (16) are sized and positioned so that the tongues slot into the pre-cuts to lock the box together in the assembled configuration.

This invention relates to a blank for the construction of a file storage box, and to a storage box constructed from such a blank

In most offices, the papers pertaining to a particular job or topic are stored in a wrapper known as a file. Such files are stored in filing cabinets or fling cupboards, either by placing the files on shelves or positioning the files in rail-mounted hangers. In either case, it is often difficult to locate and retrieve a particular file. Thus, for files positioned in rail-mounted hangers, it may be necessary to remove, at least partially, several files from their hangers before the file being searched for is located. Similarly, for files stacked on shelves, it may be necessary for several files to be slid out, at least partially before the correct file is located. The resulting multiplicity of file movements is not only time-consuming, but may also lead to damage to files as they are slid into, and out of, position on shelves, or into and out of hangers. This is particularly the case where files are stacked tightly on shelves.

The present invention provides a blank for the construction of a file storage box, the blank being formed from a single sheet of material, and having first and second substantially identical rectangular panels joined together by a third rectangular panel at respective first and second fold lines, fourth and fifth substantially identical rectangular panels joined to the first panel at opposite sides thereof by third and fourth fold lines at right-angles to the first fold line, and sixth and seventh substantially identical rectangular panels joined to the second panel at opposite sides thereof by fifth and sixth fold lines at right-angles to the second fold line, wherein the fourth and fifth panels are each provided with at least one tongue joined thereto on that edge opposite to the respective third or fourth fold line, and the sixth and seventh panels are each provided with at least one pre-cut formed in the region of the respective fifth or sixth fold line, the blank being foldable about the fold lines to form a file storage box of which the sides are constituted by the first and second panels, the base is constituted by the third panel, the front is constituted by the fourth and sixth panels and the rear is constituted by the fifth and seventh panels, the tongues and pre-cuts being sized and positioned so that the tongues slot into the pre-cuts to lock the box together in the assembled configuration.

In a preferred, embodiment, an eighth panel is joined to the fourth panel at a seventh fold line, and a ninth panel is joined to the fifth panel at an eighth fold line, the eighth panel being separated from the third panel by a first cut line and from the sixth panel by a second cut line, and the ninth panel being separated from the third panel by a third cut line and from the seventh panel by a fourth cut line. Preferably, the eighth and ninth panels are substantially square.

Advantageously, the fourth and fifth panels are each provided with two tongues, and the sixth and seventh panels are each provided with complementary pre-cuts.

Preferably, each tongue is joined to its respective fourth or fifth panel by a respective fold line, which is parallel to, and off-set inwardly from, said edge. Conveniently, each of the tongues has a trapezoidal main portion and an integral rectangular portion, the base of the trapezoidal portion being longer than the adjacent side of the rectangular portion, the sides of the trapezoidal portion tapering towards the free end of the tongue, and the opposite side of the rectangular portion being defined by the fold line joining that tongue to the respective fourth or fifth panel. Preferably, the base of the trapezoidal portion of each tongue is longer than the associated pre-cut.

The sheet of material may be made of translucent polypropylene.

The invention also provides a file storage box formed by folding a one-piece blank, the box having a pair of side panels, a front panel, a rear panel and a base panel, the blank being as defined above, wherein the box is maintained in its assembled configuration by slotting the tongues into the associated pre-cuts.

Preferably, the blank is made from resilient material so that the tongues can be inserted into the pre-cuts and snap into position with the end portions of the bases of the trapezoidal portions engaging behind portions of the blank immediately adjacent to the ends of the associated pre-cuts.

An embodiment of the invention will now be described, by way of example, with reference to the drawings, in which:

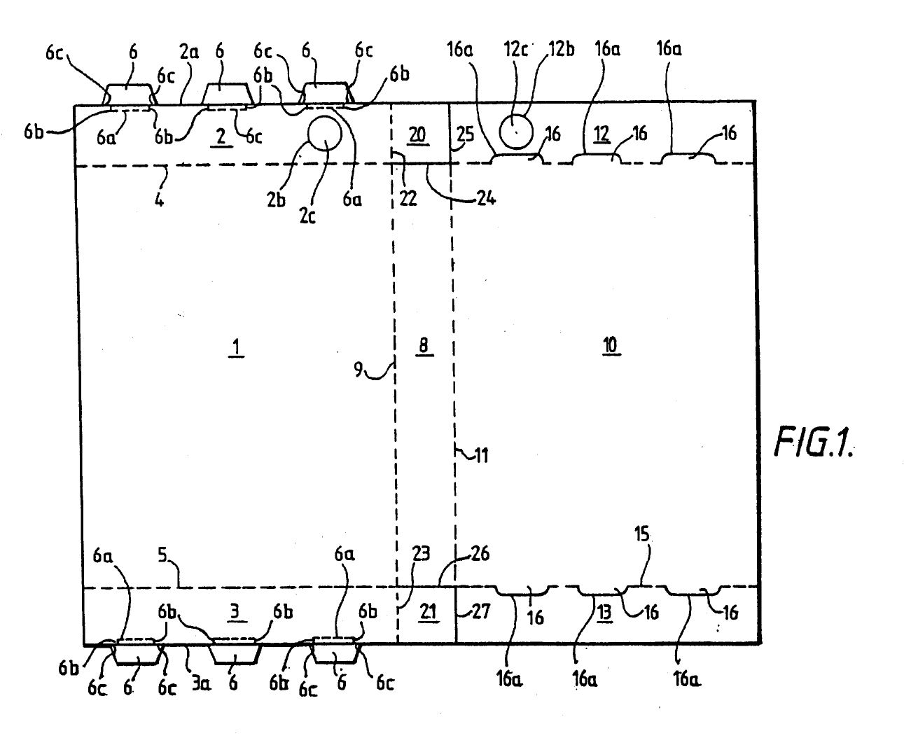

FIG. 1 is a plan view of a blank for use in forming a file storage box;

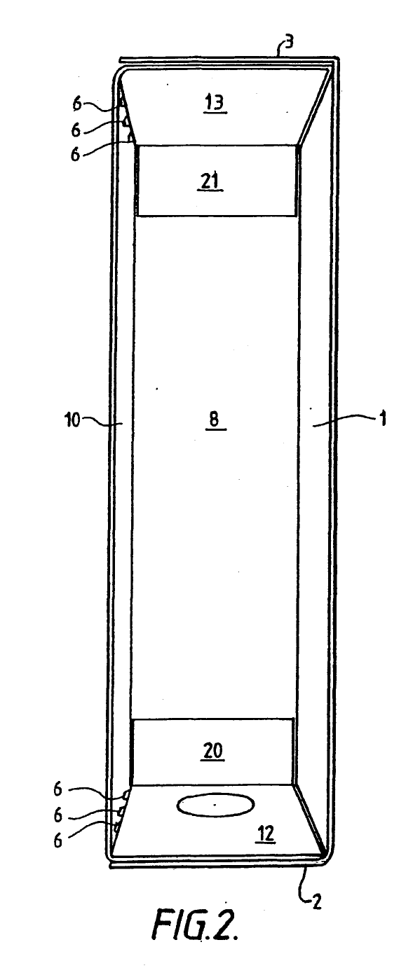

FIG. 2 is a perspective view of the assembled file storage box;

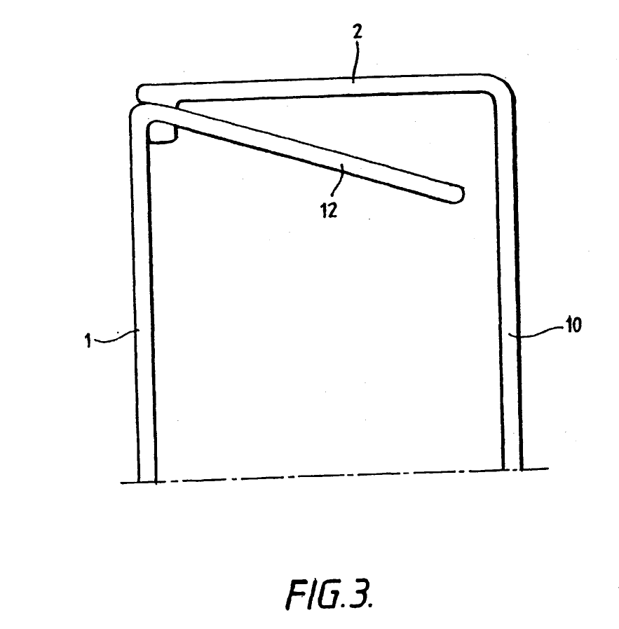

FIG. 3 is a partial perspective view of the front and top of the assembled file storage box; and

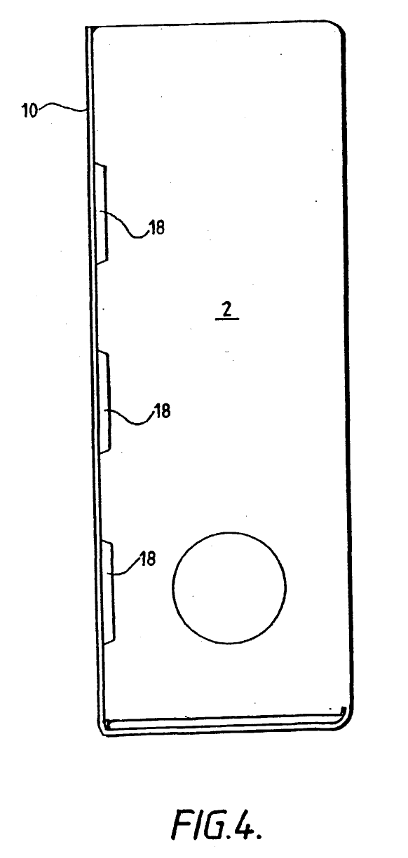

FIG. 4 is a front elevation of the assembled file storage box.

Referring to the drawings, FIG. 1 shows a blank forming a file storage box, the blank is of one-piece construction, and is made from a single flat sheet of 1200 micron translucent polypropylene. The sheet is pre cut and formed with fold lines, in a manner to be described below, so as to allow a box to be assembled from the blank.

The blank incorporates a rectangular panel 1 which, in use, forms one side of the file storage box. This panel has dimensions of 374 mm by 265 mm. The panel 1 is connected to first and second end panels 2 and 3 by respective fold lines 4 and 5. Each of the panels 2 and 3 is generally rectangular, having dimensions of 265 mm by 50 mm. The panel 2 is formed with three generally trapezoidal tongues 6, each of which is connected to that panel by a respective fold line 6a which is inset slightly from the outer edge 2a of that panel. Each of the fold lines 6a has a length of 30 mm, and respective pre-cuts 6b connect the opposite ends of the fold lines to the edge 2a of the panel 2. As shown, the base of each of the tongues 6 (that is to say that portion which, in the flat blank, lies against the edge 2a of the panel) has a length of 39 mm. Consequently, the angle between each of the inclined side edges of each tongue 6 and its fold line 6a is a re-entrant angle.

The panel 3 is also formed with three generally trapezoidal tongues 6, each of which is connected to that panel by a respective fold line 6a which is inset slightly from the outer edge of that panel. Each of the fold lines 6a has a length of 30 mm, and respective pre-cuts 6b connect the opposite edges of the fold lines to the edge 3a of the panel 3. As shown, the base of each of the tongues 6 of the panel 3 (that is to say that portion which, in the flat blank lies against the edge 3a of the panel) has a length of 39 mm.

The panel 1 is connected to a rectangular panel 8 about a fold line 9, this panel having dimensions of 374 mm by 50 mm. In use, the panel 8 forms the base of the file storage box. The panel 8 is connected to a panel 10 about a fold line 11, the panel 10 being rectangular and having dimensions of 374 mm by 265 mm. In use, the panel 10 forms the opposite side panel of the assembled file storage box to the panel 1.

The panel 10 is connected to first and second end panels 12 and 13 by respective fold lines 14 and 15. Each of the panels 12 and 13 is generally rectanular, having dimensions of 265 mm by 50 mm. The panel 12 is formed with three generally trapezoidal tags 16, each tag being defined by a pre-cuts 16a The base of each tag 16 (that is say that portion of the tag which is co-linear with the respective fold line 14 or 15) has a dimension of 37 mm, and the parallel edge of that tag has a dimension of 30 mm. The tags 16 and their pre-cuts 16a define apertures 18 (see FIG. 4) that are intended to receive the tongues 6 of the panel 2 when the box is assembled in a manner described below.

Each of the panels 2 and 3 is connected to a respective further panel 20 and 21 by respective fold lines 22 and 23. Each of the panels 20 and 21 is generally square, having dimensions of 50 mm by 50 mm Each panel 20, 21 is formed from the single sheet of material from which the blank is made by pre-cuts 24, 25 and 26, 27 respectively.

A respective circular aperture 2b, 12b is formed by pre-cuts 2c and 12c in each of the panels 2 and 12. As shown, the aperture 2b is positioned adjacent to the tongue 6 closest to the fold line 22, and the aperture 12b is adjacent to the tag 16 closest to the pre-cut 25. The pre-cuts 2b and 12b are preferably not quite complete, so that circular push-out portions of the sheet material remain in position within the apertures 2c and 12c until the box is assembled.

In use, a file storage box is formed from the blank in the following manner:

(i) The side panels 1 and 10 are folded upwardly about the fold lines 9 and 11 until they are generally parallel and at right-angles to the panel 8. At the same time, the panels 20 and 21 are folded about the fold lines 22 and 23, and are positioned to overlie the inside the end portions of the panel 8.

(ii) The panels 12 and 13 are then folded inwardly about the fold lines 14 and 15 so as to lie substantially at right-angles to the panel 10.

(iii) The panels 2 and 3 are then folded inwardly about the fold lines 4 and 5 and positioned outwardly of the panels 12 and 13.

(iv) The tongues 6 are inserted into the apertures 18. Owing to the shape and configuration of the tongues 6 and the apertures 18, the tongues can be slid into their apertures relatively easily until they snap into position with edge portions 6c thereof locked behind the edges of the apertures. In this connection, it will be recalled that the base of each of the tongues 6 has a length of 39 mm, whereas the maximum length of each of the apertures 18 defined by the base of the respective tag 16 is 37 mm. It will be appreciated that the tongues 6 can be pushed into the apertures 18 despite this dimensional difference owing to the resilience of the sheet material from which the blank is made.

v) The circular portions of the blank defined by the pre-cuts 2b and 12b are then removed by pushing them out, the resultant aperture defining a suitable finger slot for facilitating sliding of the box into, and out of; position on a shelf. If required, a label (not shown) can be inserted between the panels 2 and 12, by bending the panel 12 slightly inwardly (see FIG. 3) and pushing the label downwardly between the two panels. The label can be used to identify a file which is stored in the box, and can easily be read owing to the translucent nature of the material from which the blank is made.

File storage boxes constructed in the manner described above have the advantages of being strong, durable and lightweight, so that they protect files stored therein. Consequently, the use of file storage boxes of this type substantially reduces damage to the stored files as they are pushed onto, and removed from, file storage shelves. Moreover, the use of labels positioned between the panels 2 and 12 facilitates file location, and hence reduces the chances of incorrect files being removed from a file storage shelf. Indeed, the use of labels enables files to be quickly and easily identified without even needing to touch the files or their boxes, never mind having to remove them either partially or completely. It is envisaged that the labels would be pre-formed by perforations on a sheet (of say A4) paper. The labels would then be word-processed and pushed-out from the sheet ready for insertion into the front panels of file storage boxes. Alternatively, the labels could be word-processed using a template generates a plurality of approprately-dimensioned labels. Labels could then be generated by appropriate word-processing and subsequent guillotining. In this case, the sheets from which the labels are cut could be preformed with holes to match the finger holes in the front panels of the file storage boxes. Alternatively, holes in the labels could be made, using a suitable hole punch, after the word-processing step. The labels would also be used to bear other information such as a firm's logo.

Another advantage of the invention is that the supply of blanks can be stored as a flat pack, prior to use, so that the space required for storing the items is minimised.

It will be apparent that modifications could be made to the blank described above. In particular, the dimensions of the panels could be varied to complement files other than foolscap files. In particular, for storing invoices or correspondence, the panels could be dimensioned to suit a particular invoice size or be of A4 size to suit the normal size of correspondence paper. In particular, the dimensions of the blank could be modified so that the finished box has a width of 75 mm and 100 mm instead of 50 mm, that is to say the panels 2, 3, 8, 12 and 13 each have a “width” of 75 mm or 100 mm instead of 50 mm. Obviously, any other desired box width could be achieved by appropriately modifying the widths of these panels. It would also be possible to tint the translucent polypropylene material with different hues to identify different types of files to be stored. Alternatively, labels of different colours could be used to identify different types of files. Moreover, although polypropylene is a preferred material being strong, durable and lightweight, it would also be possible to make the blank from other sheet materials such as cardboard

1. A blank for the construction of a file storage box, the blank being formed from a single sheet of material, and having first and second substantially identical rectangular panels joined together by a third rectangular panel at respective first and second fold lines, fourth and fifth substantially identical rectangular panels joined to the first panel at opposite sides thereof by third and fourth fold lines at right-angles to the first fold line, and sixth and seventh substantially identical rectangular panels joined to the second panel at opposite sides thereof by fifth and sixth fold lines at right-angles to the second fold line, wherein the fourth and fifth panels are each provided with at least one tongue joined thereto on that edge opposite to the respective third or fourth fold line, and the sixth and seventh panels are each provided with at least one pre-cut formed in the region of the respective fifth or sixth fold line, the blank being foldable about the fold lines to form a file storage box of which the sides are constituted by the first and second panels, the base is constituted by the third panel the front is constituted by the fourth and sixth panels and the rear is constituted by the fifth and seventh panels, the tongues and pre-cuts being sized and positioned so that the tongues slot into the pre-cuts to lock the box together in the assembled configuration.

2. A blank as claimed in claim 1, wherein an eighth panel is joined to the fourth panel at a seventh fold line, and a ninth panel is joined to the fifth panel at an eighth fold line, the eighth panel being separated from the third panel by a first cut line and from the sixth panel by a second cut line, and the ninth panel being separated from the third panel by a third cut line and from the seventh panel by a fourth cut line.

3. A blank as claimed as in claim 2, wherein the eighth and ninth panels are substantially square.

4. A blank as claimed in any one of claims 1 to 3, wherein the fourth and fifth panels are each provided with two tongues, and the sixth and seventh panels are each provided with complementary pre-cuts.

5. A blank as claimed in any one of claims 1 to 4, wherein each tongue is joined to its respective fourth or fifth panel by a respective fold line, which is parallel to, and off-set inwardly from, said edge.

6. A blank as claimed in claim 5, wherein each of the tongues has a trapezoidal main portion and an integral rectangular portion, the base of the trapezoidal portion being longer than the adjacent side of the rectangular portion, the sides of the trapezoidal portion tapering towards the free end of the tongue, and the opposite side of the rectangular portion being defined by the fold line joining that tongue to the respective fourth or fifth panel.

7. A blank as claimed in claim 6, wherein the base of the trapezoidal portion of each tongue is longer than the associated prey.

8. A blank as claimed in any one of claims 1 to 7, wherein the sheet of material is made of translucent polypropylene.

9. A file storage box formed by folding a one-piece blank, the box having a pair of side panels, a front panel, a rear panel and a base panel, the blank as being claimed in any one of claims 1 to 8, wherein the box is maintained in its assembled configuration by slotting the tongues into the associated pre-cuts.

10. A file storage box as claimed in claim 9 when appendant to claim 7, wherein the blank is made from resilient material so that the tongues can be inserted into the pre-cuts and snap into position with the end portions of the bases of the trapezoidal portions engaging behind portions of the blank immediately adjacent to the ends of the associated pre-cuts.

11. A blank for the construction of a file storage box, the blank being substantially as hereinbefore described with reference to, and as illustrated by, FIG. 1 of the drawings.

12. A file storage box substantially as hereinbefore described with reference to, and as illustrated by, the drawings.
